(19) United States
(12) Patent Application Publication
(10) Pub. No.: US 2025/0078463 A1
(43) Pub. Date: Mar. 6, 2025

(54) REGION-BASED OBJECT DETECTION WITH CONTEXTUAL INFORMATION

(71) Applicant: THE BOEING COMPANY, Arlington, VA (US)

(72) Inventors: Esteban F. LOPEZ, Bridgeton, MO (US); Liessman E. STURLAUGSON, St. Louis, MO (US); Peter G. RHODES, Ladson, SC (US)

(21) Appl. No.: 18/617,432

(22) Filed: Mar. 26, 2024

Related U.S. Application Data
(60) Provisional application No. 63/580,588, filed on Sep. 5, 2023.

(51) Int. Cl. G06V 10/764; G06V 10/77

(52) U.S. Cl. CPC G06V 10/764; G06V 10/7715

(57) ABSTRACT

The present disclosure provides a method of detecting one or more objects in an image in one aspect, the method including receiving a first portion of the image at a first feature extractor to provide a first feature vector. The first portion has an object depicted therein. The method further includes receiving a second portion of the image at a second feature extractor to provide a second feature vector. The second portion is different from the first portion. The method further includes classifying the object using a classification model. Classifying the object comprises applying at least the first feature vector and the second feature vector to the classification model.

### CROSS-REFERENCE TO RELATED APPLICATIONS

This application claims benefit of U.S. provisional patent application Ser. No. 63/580,588, filed Sep. 5, 2023, which is incorporated herein by reference in its entirety.

### FIELD

Aspects of the present disclosure relate to computer vision, and more specifically, techniques for an improved ability to detect objects in images by introducing contextual information.

### BACKGROUND

Object detection is a fundamental function in computer vision that involves identifying and locating objects depicted in an image or a video sequence. As used herein, the “object detection” function may be performed as part of various categories of computer vision techniques, such as image classification, object detection, and image segmentation. Object detection is used in various applications, such as autonomous vehicles, security services, image recognition, and augmented reality.

Object detection models are typically provided with a portion of an image (sometimes termed as a “crop” or a “cell”) for object detection. However, it is possible that the portion of the image contains insufficient information for the object detection model to identify and correctly classify an object depicted in the portion. This implies the existence of a minimum bound on the size of the portion. However, if the bounds of the portion are increased, the object detection model may identify an object other than the object of interest. Further, unless the resolution of the portion is decreased, increasing the size of the portion tends to result in slower training times for the object detection model and/or requires additional computing resources.

### SUMMARY

The present disclosure provides a method of detecting one or more objects in an image in one aspect, the method including: receiving a first portion of the image at a first feature extractor to provide a first feature vector. The first portion has an object depicted therein. The method further includes receiving a second portion of the image at a second feature extractor to provide a second feature vector. The second portion is different from the first portion. The method further includes classifying the object using a classification model. Classifying the object comprises applying at least the first feature vector and the second feature vector to the classification model.

In one aspect, in combination with any example method above or below, the second portion is larger than the first portion and fully overlaps the first portion.

In one aspect, in combination with any example method above or below, the object is depicted in the second portion.

In one aspect, in combination with any example method above or below, the method further includes receiving positional information indicating a position of the first portion relative to at least the second portion. Classifying the object further comprises applying the positional information to the classification model.

In one aspect, in combination with any example method above or below, the second portion is the image, and the positional information comprises one of coordinates of the first portion within the image, and a position vector of the first portion within the image.

In one aspect, in combination with any example method above or below, one or both of the first feature extractor and the second feature extractor have pretrained fixed parameters. The method further includes training the classification model using outputs from the first feature extractor and the second feature extractor.

In one aspect, in combination with any example method above or below, the image depicts external surfaces of a plurality of sections of an aircraft, the first portion of image depicts an external surface of a first section of the plurality of sections, and classifying the object comprises distinguishing the first section.

The present disclosure provides a computer program product in one aspect, the computer program product including: a computer-readable storage medium having computer-readable program code embodied therewith. The computer-readable program code executable by one or more computer processors to perform an operation including receiving a first portion of the image at a first feature extractor to provide a first feature vector. The first portion has an object depicted therein. The operation further includes receiving a second portion of the image at a second feature extractor to provide a second feature vector. The second portion is different from the first portion. The operation further includes classifying the object using a classification model. Classifying the object comprises applying at least the first feature vector and the second feature vector to the classification model.

In one aspect, in combination with any example computer program product above or below, the second portion is larger than the first portion and fully overlaps the first portion.

In one aspect, in combination with any example computer program product above or below, the object is depicted in the second portion.

In one aspect, in combination with any example computer program product above or below, the operation further includes receiving positional information indicating a position of the first portion relative to at least the second portion. Classifying the object further comprises applying the positional information to the classification model.

In one aspect, in combination with any example computer program product above or below, the second portion is the image, and the positional information comprises one of coordinates of the first portion within the image, and a position vector of the first portion within the image.

In one aspect, in combination with any example computer program product above or below, one or both of the first feature extractor and the second feature extractor have pretrained fixed parameters. The operation further includes training the classification model using outputs from the first feature extractor and the second feature extractor.

In one aspect, in combination with any example computer program product above or below, the image depicts external surfaces of a plurality of sections of an aircraft, the first portion of image depicts an external surface of a first section of the plurality of sections, and classifying the object comprises distinguishing the first section.

The present disclosure provides a system in one aspect, the system including one or more processors, and a memory storing instructions that when executed by the one or more processors enable performance of an operation of detecting one or more objects in an image. The operation includes receiving a first portion of the image at a first feature extractor to provide a first feature vector. The first portion has an object depicted therein. The operation further includes receiving a second portion of the image at a second feature extractor to provide a second feature vector. The second portion is different from the first portion. The operation further includes classifying the object using a classification model. Classifying the object comprises applying at least the first feature vector and the second feature vector to the classification model.

In one aspect, in combination with any example system above or below, the second portion is larger than the first portion and fully overlaps the first portion.

In one aspect, in combination with any example system above or below, the object is depicted in the second portion.

In one aspect, in combination with any example system above or below, the operation further includes receiving positional information indicating a position of the first portion relative to at least the second portion. Classifying the object further comprises applying the positional information to the classification model.

In one aspect, in combination with any example system above or below, the second portion is the image, and the positional information comprises one of coordinates of the first portion within the image, and a position vector of the first portion within the image.

In one aspect, in combination with any example system above or below, one or both of the first feature extractor and the second feature extractor have pretrained fixed parameters. The operation further includes training the classification model using outputs from the first feature extractor and the second feature extractor.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts an example system for object detection using contextual information, according to one or more aspects.

FIG. 2 is a diagram of an example implementation of an object detection service using contextual information, according to one or more aspects.

FIG. 3 depicts example classifications using different portions of an image, according to one or more aspects.

FIG. 4 depicts example classifications using different portions of an image, according to one or more aspects.

FIG. 5 is an example method of object detection using contextual information, according to one or more aspects.

### DETAILED DESCRIPTION

Region-based object detection operates on portions of images, instead of full images, typically to provide improved speed and/or computational efficiency of the object detection. Region-based object detection tends to exhibit a number of challenges, such as missing objects of interest that are located outside the specified region of interest, identifying and localizing multiple overlapping or occluding objects, heightened sensitivity to the selection of regions of interest (possibly yielding false positives or negatives), maintaining accurate object detection and tracking over time, detecting objects of different scales effectively, and coordinating selection of regions for multiple objects.

Region-based object detection also tends to suffer from incomplete context. By focusing on specific regions, the algorithm lacks the broader context of the entire image. Such context is crucial for understanding relationships between objects, scene understanding, and making more informed decisions. Ignorance of the broader context leads to misinterpretations or misclassifications. Naturally, for those applications requiring a comprehensive understanding of an entire image, e.g., image segmentation or scene understanding, region-based object detection might not be the most suitable approach.

The present disclosure provides techniques for an improved ability to detect objects in images by introducing contextual information. In some aspects, a method of detecting one or more objects in an image is disclosed. The method comprises receiving a first portion of the image at a first feature extractor to provide a first feature vector, the first portion having an object depicted therein. The method further comprises receiving a second portion of the image at a second feature extractor to provide a second feature vector, the second portion being different from the first portion. The method further comprises classifying the object using a classification model. Classifying the object comprises applying at least the first feature vector and the second feature vector to the classification model.

In various aspects, contextual object detection is performed by providing a classification model with (1) a portion of an image (e.g., at an original pixel resolution) in which an object is to be detected, (2) another portion of the image (in some cases, the entire image) that may be at a downscaled resolution, and optionally (3) positional information for the first portion relative to the other portion (or to the entire image). Using this approach, the classification model can provide improved performance for classifying objects that are similar in appearance but can only be correctly distinguished by the context surrounding the object. This issue can arise when detecting damage on external surfaces of an aircraft, as it may not be possible to distinguish which external surface is depicted within a zoomed-in crop.

Further, in using the techniques discussed herein to provide the context to the classification model, an object detection algorithm need not impose a minimum bound constraint, as there is no longer a strict requirement for the portion of the image to include sufficient information within its bounds. In this way, the techniques enable object detection algorithms to detect smaller objects and/or to detect objects with greater precision.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

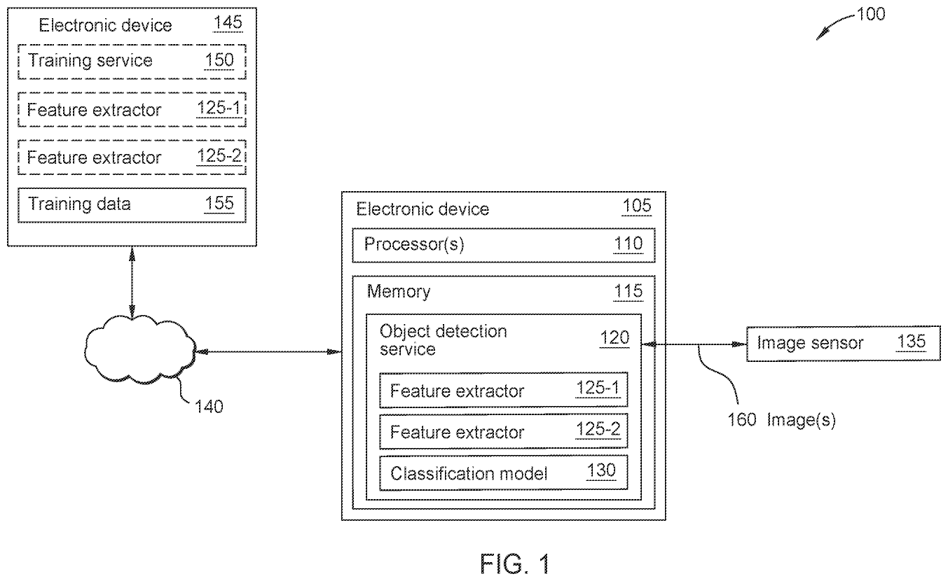

FIG. 1 depicts an example system 100 for object detection using contextual information, according to one or more aspects. The features of the system 100 may be used in conjunction with other aspects.

The system 100 comprises an electronic device 105 that is communicatively coupled with an image sensor 135. As used herein, an “electronic device” generally refers to any device having electronic circuitry that provides a processing or computing capability, and that implements logic and/or executes program code to perform various operations that collectively define the functionality of the electronic device. The functionality of the electronic device includes a communicative capability with one or more other electronic devices, e.g., when connected to a same network. An electronic device may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any suitable techniques, such as conductive cabling, wireless transmission, optical transmission, and so forth. Further, although described as being performed by a single electronic device, in other aspects, the functionalities of the system 100 may be performed by a plurality of electronic devices.

The electronic device 105 comprises one or more processors 110 and a memory 115. The one or more processors 110 are any electronic circuitry, including, but not limited to one or a combination of microprocessors, microcontrollers, application-specific integrated circuits (ASIC), application-specific instruction set processors (ASIP), and/or state machines, that is communicatively coupled to the memory 115 and controls the operation of the system 100. The one or more processors 110 are not limited to a single processing device and may encompass multiple processing devices.

The one or more processors 110 may include other hardware that operates software to control and process information. In some aspects, the one or more processors 110 execute software stored in the memory 115 to perform any of the functions described herein. The one or more processors 110 control the operation and administration of the electronic device 105 by processing information (e.g., information received from input devices and/or communicatively coupled electronic devices).

The memory 115 may store, either permanently or temporarily, data, operational software, or other information for the one or more processors 110. The memory 115 may include any one or a combination of volatile or non-volatile local or remote devices suitable for storing information. For example, the memory 115 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 115, a disk, a CD, or a flash drive. In particular embodiments, the software may include an application executable by the one or more processors 110 to perform one or more of the functions described herein.

In this example, the memory 115 stores an object detection service 120 that receives one or more images 160 from the image sensor 135, and identifies and classifies one or more objects depicted within the one or more images 160. The image sensor 135 may have any suitable implementation, such as a visible light sensor (e.g., a RGB camera) or an infrared (IR) light sensor. Other aspects of the image sensor 135 may use non-destructive inspection techniques to generate the one or more images 160, such as shearography. The one or more images 160 may be provided in any suitable format, such as individual images or a sequence of images (e.g., video).

The object detection service 120 may be implemented with any suitable architecture, such as Faster R-CNN, Single Shot MultiBox Detector (SSD), and You Only Look Once (YOLO). The object detection service 120 may perform a number of different operations using the received one or more images 160. In some aspects, the object detection service 120 performs preprocessing of the one or more images 160 to enhance features, reduce noise, and/or standardize the input for the detection model. For example, the object detection service 120 may perform one or more of resizing, normalization, and color space conversion of the one or more images 160.

In some aspects, the object detection service 120 generates a plurality of crops (or cells) from the one or more images 160. The crops may have any suitable sizing, e.g., 224×224 pixels. In some aspects, the object detection service 120 systematically progresses across (e.g., sweeps across) an individual image of the one or more images 160 to generate a plurality of crops for the image. Other techniques for selecting regions to generate a plurality of crops are also contemplated. The crops may or may not be partially overlapping with each other. In some aspects, the object detection service 120 may perform multiple passes of an individual image to generate pluralities of crops of different sizes.

In some aspects, the object detection service 120 generates positional information for pairs of a first portion of an image (e.g., a crop of the image, or the entire image itself) and a second portion of the image that is different than first portion (e.g., another crop of the image, or the entire image itself). In some aspects, the second portion of the image is larger than the first portion of the image. In some aspects, the first portion of the image is partly or fully overlapped by the second portion of the image, such that an object that is depicted in the first portion is also depicted in the second portion. The positional information indicates a position of the first portion relative to at least the second portion. The positional information may be generated with any suitable formatting, e.g., a position vector that includes X, Y coordinates or scaled values (0-100%) along the X, Y dimensions.

The object detection service 120 comprises multiple feature extractors 125-1, 125-2 for performing feature extraction of an input image. In some aspects, the first portion of the image is provided to a first one of the feature extractors 125-1, 125-2, and the second portion of the image is provided to a second one of the feature extractors 125-1, 125-2. Further, although two feature extractors 125-1, 125-2 are depicted, alternate implementations of the system 100 may include a different number of feature extractors.

In some aspects, each of the feature extractors 125-1, 125-2 comprises a respective Convolutional Neural Network (CNN). Each CNN learns hierarchical representations of the input image (e.g., the crop or the entire image), capturing features of the input image at different levels of abstraction. Deeper layers of the CNN tend to capture high-level semantic features, while shallower layers of the CNN tend to capture low-level features like edges and textures. Other architectures of the feature extractors 125-1, 125-2 are also contemplated, such as neural networks using self-attention layers, capsule networks, dynamic convolutional networks, transformer networks, and spatial transformer networks.

In some aspects, the object detection service 120 comprises a Region Proposal Network (RPN) that proposes candidate regions in the image that are likely to depict objects. The object detection service 120 may further perform Region of Interest (RoI) pooling to transform the candidate regions into fixed-size feature vectors (or “feature maps”), enabling the object detection service 120 to process candidate regions that have different sizes and/or shapes.

The object detection service 120 further comprises a classification model 130. In some aspects, the classification model 130 comprises a classifier that receives the feature vectors output by the feature extractors 125-1, 125-2, as well as the corresponding positional information generated by the object detection service 120, and determines the class of the object depicted within the candidate region. The classifier may have any suitable implementation, e.g., a neural network comprising a plurality of fully-connected layers and a softmax classification layer, a decision tree classifier, a support vector machine, a Bayesian network, or an ensemble model. Other aspects of the classifier are also contemplated, e.g., other types of feedforward neural networks. In some aspects, the classification model 130 further comprises a regressor that refines the bounding box coordinates to precisely localize the object. In some aspects, the object detection service 120 applies Non-Maximum Suppression (NMS) to suppress redundant detections (e.g., overlapping bounding boxes) and/or low-confidence detections.

In some aspects, the object detection service 120 performs one or more post-processing operations, such as converting the bounding boxes and class probabilities into different formats. For example, the object detection service 120 may filter out those object detections that are below a predefined confidence threshold, and/or map class indices to human-readable labels.

In some aspects, the object detection service 120 performs the training of the feature extractors 125-1, 125-2 and the classification model 130, e.g., using a set of training data 155. The training data 155 is generally provided with a similar form as the operational data, e.g., a first portion and a second portion of each of a plurality of images, as well as positional information indicating a position of the first portion relative to at least the second portion. As shown, the training data 155 is stored on an electronic device 145 that is separate from the electronic device 105. In some aspects, the electronic device 105 and the electronic device 145 are communicatively coupled through a network 140 (e.g., one or more local area networks (LANs) and/or a wide area network (WAN)). In other aspects, the training data 155 is stored in the memory 115 of the electronic device 105.

In other aspects, the electronic device 145 comprises a training service 150 that performs the training of one or both of the feature extractors 125-1, 125-2 using the training data 155. Once trained, the parameters (e.g., model weights) of the feature extractors 125-1, 125-2 may be frozen. In some aspects, the pretrained fixed parameters of the feature extractors 125-1, 125-2 are provided to the object detection service 120. The object detection service 120 then performs the training of the classification model 130. For example, self-supervised pre-training is done with the training data 155 without the classification model 130. Then, a supervised fine-tuning is performed with the some or all of the training data 155, but with the training done with the classification model 130 in the loop against the labeled version of the training data 155.

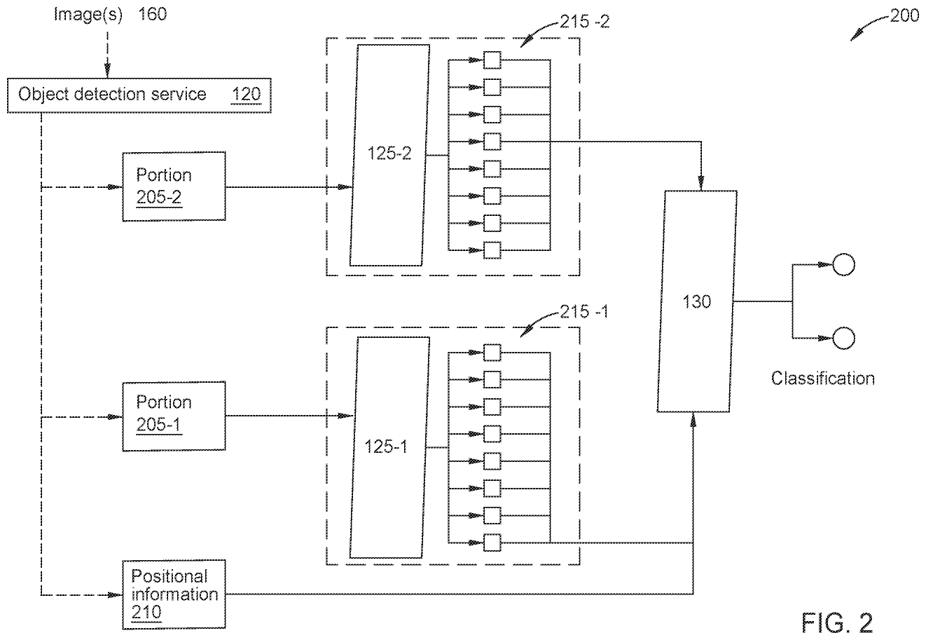

FIG. 2 is a diagram 200 of an example implementation of an object detection service using contextual information, according to one or more aspects. The features illustrated in diagram 200 may be used in conjunction with other aspects. For example, the diagram 200 may represent one example implementation of the object detection service 120 of FIG. 1.

In the diagram 200, the object detection service 120 receives one or more images 160. As mentioned above, the one or more images 160 may be provided in any suitable format, such as individual images or a sequence of images (e.g., video). The object detection service 120 generates a plurality of crops (or cells) from the one or more images 160. Individual crops of the plurality of crops may have any suitable size(s). Within the plurality of crops, some crops may be partly or fully overlapping with each other. In some aspects, the object detection service 120 generates positional information 210 for pairs of a first portion 205-1 of one image of the image(s) 160 (e.g., a crop of the image) and a second portion 205-2 of the one image (e.g., another crop of the image, or the entire image itself). The positional information 210 indicates a position of the first portion 205-1 relative to at least the second portion 205-2. Further, although two portions 205-1, 205-2 are illustrated, alternate aspects may include different numbers of portions (e.g., three or more).

The first portion 205-1 of the image is provided to a first feature extractor 125-1, and the second portion 205-2 of the image is provided to a second feature extractor 125-2. In some aspects, the first feature extractor 125-1 and the second feature extractor 125-2 comprises a respective CNN, although other machine learning architectures are also contemplated. In some aspects, one or both of the first feature extractor 125-1 and the second feature extractor 125-2 comprises an RPN that proposes candidate regions for detecting objects.

The first feature extractor 125-1 outputs a first feature vector 215-1 representative of the first portion 205-1, and the second feature extractor 125-2 outputs a second feature vector 215-2 representative of the second portion 205-2. In some aspects, one or both of the first feature extractor 125-1 and the second feature extractor 125-2 further comprises a RoI pooling layer that transforms the candidate regions from the RPN, causing the feature vectors 215-1, 215-2 to be generated with a predetermined size. The classification model 130 receives the first feature vector 215-1, the second feature vector 215-2, and optionally the positional information 210, and determines the class and/or bounds of the object depicted within the candidate region.

As shown in the diagram 200, the first feature extractor 125-1 and the second feature extractor 125-2 are arranged in parallel with each other. In some alternate aspects, the first feature extractor 125-1 and the second feature extractor 125-2 may be arranged in series, where the feature vector 215-1, 215-2 output from a respective one of the feature extractors 125-1, 125-2 is provided as an additional input to the other of the feature extractors 125-1, 125-2. For example, the feature vector 215-2 from the second feature extractor 125-2 (corresponding to the “zoomed out” image portion) may be fed into the first feature extractor 125-1. Further, other implementations of the object detection service 120 may include different numbers of feature extractors, such as a first feature extractor receiving a first crop, a second feature extractor receiving a larger second crop, and a third feature extractor receiving the entire image.

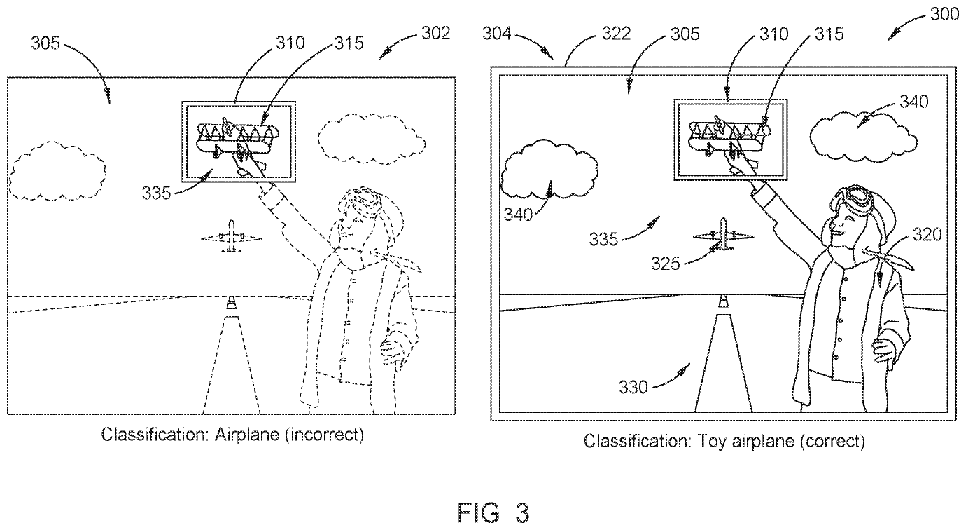

FIG. 3 is a diagram 300 depicting example classifications using different portions of an image, according to one or more aspects. The features in the diagram 300 may be used in conjunction with other aspects, e.g., to illustrate example operation of the object detection service 120 of FIGS. 1 and 2.

The diagram 300 includes a left-side instance 302 and a right-side instance 304 of an image 305. The left-side instance 302 represents the operation of a conventional object detection model, which is provided with only a crop 310 of the image 305. The portions of the image 305 outside the crop 310 are shown in broken lines to indicate additional information within the image 305 that is not considered by the object detection model.

An object is depicted within the crop 310, and more specifically, a toy airplane 315 that is held by a child 320 with a background of sky 335. Although a portion of a hand of the child 320 is also depicted within the crop 310, the object detection model lacking the greater context of the image 305 may identify the object with sufficient confidence to classify the object as an airplane, albeit incorrectly.

Using various aspects described herein, the object detection service 120 receives the crop 310 representing a first portion of the image 305, and receives the entire image as a second portion 322 of the image 305. Notably, the second portion 322 completely overlaps the crop 310 and also depicts the toy airplane 315 (the object of interest). The second portion 322 further depicts the child 320 in the foreground, standing on a runway 330, while an airplane 325 takes off from the runway 330 in the background. The second portion 322 further depicts several clouds 340 in the sky 335.

The object detection service 120 further receives positional information describing the position of the crop 310 relative to the second portion 322. In other cases, the second portion 322 need not be coextensive with the image 305. Given the greater context of the image 305, the object detection service 120 may correctly classify the object as the toy airplane 310.

In some cases, the greater context of the image 305 may include contextual information that is based on parts of the image 305 that do not contain the object of interest. For example, if the first portion (e.g., the crop 310) “looks” at the toy airplane 315, the second portion 322 might “look” at a portion of the image 305 that depicts only the child 320. The object detection service 120 may interpret the toy airplane 315 as such, e.g., based on a size difference between the toy airplane 315 and the child 320, that children tend to appear around toys, and so forth.

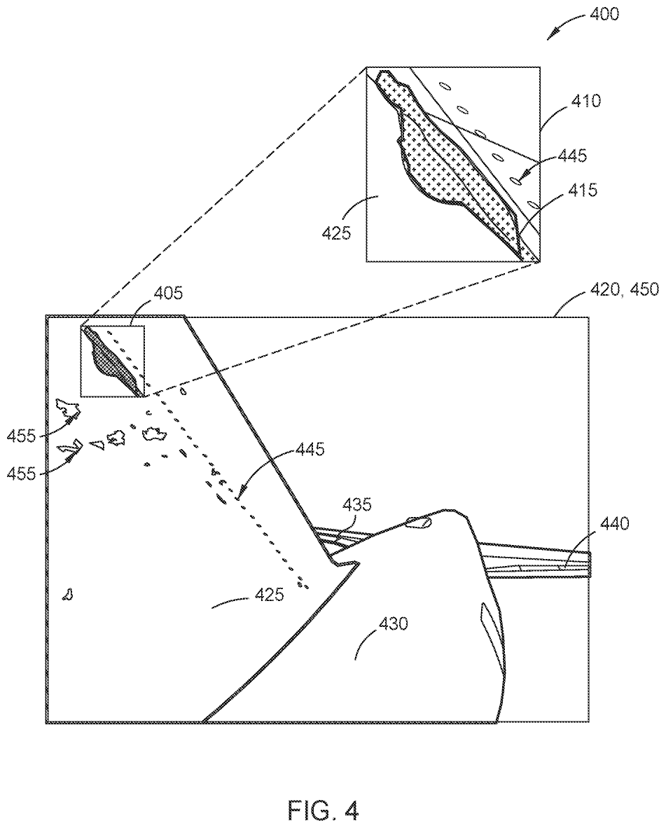

FIG. 4 is a diagram 400 depicting example classifications using different portions of an image, according to one or more aspects. The features in the diagram 400 may be used in conjunction with other aspects, e.g., to illustrate example operation of the object detection service 120 of FIGS. 1 and 2.

In the diagram 400, an image 420 depicts external surfaces of a plurality of sections of an aircraft, specifically, a vertical stabilizer 425, a fuselage 430, a left wing 435, and a right wing 440. A crop 405 of the image 420 depicts an external surface of the vertical stabilizer 425, as well as a paint defect 415 occurring near a row of fasteners 445. The diagram 400 also includes an enlarged view 410 of the crop 405 for clarity. A conventional object detection model may be able to correctly identify the location of the paint defect 415 within the crop 405. However, lacking the greater context of the image 420, the object detection model may be unable to correctly identify the paint defect 415 as such.

Using various aspects described herein, the object detection service 120 receives the crop 405 representing a first portion of the image 420, and receives the entire image 420 as the second portion 450 of the image 420. Again, the second portion 450 completely overlaps the crop 405 and also depicts the paint defect 415 (the object of interest). The second portion 450 further depicts a greater portion of the vertical stabilizer 425 (including several other paint defects 455), the fuselage 430, the left wing 435, and the right wing 440 of the aircraft.

In some aspects, the object detection service 120 further receives positional information describing the position of the crop 405 relative to the second portion 450. In other cases, the second portion 450 need not be coextensive with the image 420. Given the greater context of the image 420, the object detection service 120 distinguishes the vertical stabilizer 425 when classifying the paint defect 415, allowing the paint defect 415 to be classified with greater specificity. Beneficially, by providing a more specific classification of the paint defect 415, the object detection service 120 provides additional information that can be used to improve documentation of repairs and/or to more efficiently complete the repairs. For example, the information could be used by a maintenance management system to prioritize certain repairs or sequence the repair operations (e.g., based on the availability of machinery and/or operators). Other benefits of the object detection service 120 are also contemplated. For example, the object detection service 120 may increase the speed and consistency compared to a visual inspection by an operator.

In some aspects, the object detection service 120 may be included in a more comprehensive service that detects and documents the location of the defect on the aircraft, and that classifies the type and severity of the defect (e.g., a corrosion of size X cm², a crack of length Y cm). In some aspects, the additional information provided by the more comprehensive service may be used for the training of maintainers and/or inspectors to better understand the classification and severity of defects. In some aspects, the additional information provided by the more comprehensive service may be used to schedule maintenance (e.g., when the defect falls outside a specification).

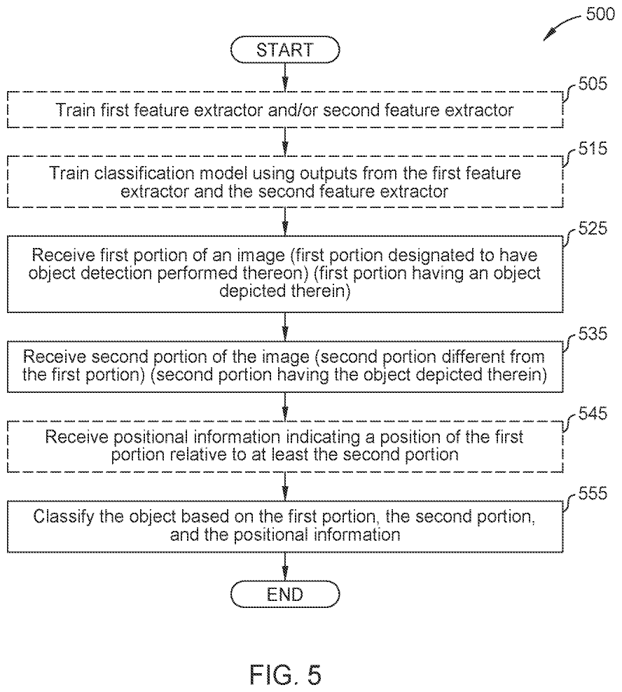

FIG. 5 is an example method 500 of object detection using contextual information, according to one or more aspects. The method 500 may be used in conjunction with other aspects. For example, the method 500 may be performed by the object detection service 120, or using the training service 150 and the object detection service 120, of FIG. 1.

Method 500 begins at optional block 505, where the object detection service 120 or the training service 150 trains a first feature extractor and/or a second feature extractor. At optional block 515, the object detection service 120 trains a classification model using outputs from the first feature extractor and the second feature extractor.

At block 525, the object detection service 120 receives a first portion of an image. The first portion is designated to have the detection of one or more objects performed thereon, and has an object depicted therein. The object may be a foreground object or a background object. In some aspects, the first portion is a crop of the image. At block 535, the object detection service 120 receives a second portion of the image. The second portion is different from the first portion and, in some cases, also has the object depicted therein. In some aspects, the second portion is the entire image. In other aspects, the second portion is another crop of the image. At an optional block 545, the object detection service 120 receives positional information indicating a position of the first portion relative to at least the second portion.

At block 555, the object detection service 120 classifies the object based on the first portion, the second portion, and the positional information. In one example, a background object depicted in the image, such as a fuselage of an aircraft, is classified as non-anomalous. The method 500 ends following completion of block 555.

Thus, in various aspects described herein, the object detection service 120 adapts the architecture of conventional object detection models to accept three inputs: (1) a partition of interest that is designated for classification (e.g., a crop), (2) a different partition of the image (e.g., a version of the entire image or a different crop at varying resolutions), and (3) a position vector indicating the coordinates or location of the partition within the entire image. This removes the minimum bound constraint of typical object detection algorithms by allowing a computer vision model to have access to the information required to interpret the context in which an image partition exists. In other words, there is no longer a strict requirement for the partition/crop to have sufficient information within its bounds, allowing object detection algorithms to detect smaller, more precise objects.

In some aspects, the object detection service 120 also solves the problem of distinguishing items of similar appearance at a certain size, where the distinguishing factor between objects is the context surrounding it. This has been a common problem observed in object detection for detecting damage on external aircraft surfaces. Conventional object detection models may be unable to distinguish which flight surface is pictured in a zoomed-in crop from that crop alone.

Another benefit of the object detection service 120 is its use of solely the image to provide contextual information to the model. Contextual information can be introduced in a variety of ways: word-labels describing the setting an image was taken in, coordinates of the camera from where the image was captured, or the date and time of image capture are a few relevant pieces of information which would aid a model in identifying objects in a crop. These artifacts, however, may not be available in all datasets for computer vision problems, preventing these solutions from being generalizable to any situation where only image-data is available. The object detection service 120 requires only the images, making it generalizable for any object detection task.

In some aspects, the architecture of the object detection service 120 can be flexible, allowing users to select their computer vision model(s)/architecture(s) and supervised head of choice. In one aspect, the architecture is a simple three-step process:
1. Pass the entire image into a whole-image model (e.g., ResNet). Note that a “whole-image model” is not required to train strictly on the entire image. Instead, the whole-image model may alternately represent a larger-crop model or a different-crop model that is trained on a larger crop or different crop (e.g. zoomed-out from the crop) from the image. An example of this is two models that both received the same-sized crop of an image but at different locations within the image, the object detection service 120 could use the information from each model to inform the final classification.
2. Pass the crop into a crop-only model. In some cases, the crop-only model may have a similar implementation as the whole-image model, but is trained using crops of different location(s) within the image.
3. Concatenate the internal representations of both the computer vision models and pass into a supervised head for final classification of the crop.

In some aspects, the training of the components of the object detection service 120 includes the ability to freeze the parameters from the whole-image or crop-only models from parameter updates during training. This allows users the ability to choose how to train the individual components of the object detection service 120. For example, one may wish to train a whole-image model separately using self-supervised pretraining, then later use that model as a component of the object detection service 120 without any further updates to the parameters of said whole-image model. Further, because the model solves the problem of differentiating items of similar appearance at a certain size—where the distinguishing factor between objects is context—the object detection service 120 model may be particularly useful in maintenance settings, in which defects are not of any one particular size or location.

One notable feature of the object detection service 120 is the architecture specifying how/what data is input into an object detection algorithm. The object detection service 120 model can be created using a variety of available computer vision or general machine learning architectures, and the use of three input-data pieces (e.g., the crop, an additional partition of the image, and position) improves an object detection algorithm. In one aspect, the object detection service 120 builds on the architecture of SimCLR (which uses a ResNet as the underlying computer vision model), however this is not a requirement. It is possible to use a singular model/feature extractor with shared parameters (model weights) for both the larger image and crop feature extractors; however, this may cause complications of the convolution between a crop and a larger image.

Another notable feature of the object detection service 120, and distinguishing from other object detection algorithms, is the ability to freeze the parameters of specific sub-models during training. This reduces training time, as model weights are updated during object detection training on an as-needs basis. This also prevents model weights from overfitting to a specific problem, as one may choose to only train the supervised head during training of the object detection service 120, utilizing the larger image and crop sub-models (which were trained on some separate task) as feature extractors. The architecture of the object detection service 120 is generalizable by allowing users to freeze the whole image and/or crop sub-models from updates during training. This mimics the behavior of a two-phase model but with the added benefit of deciding when to train certain parameters of the model which focus on particular image features.

There are no known methods used by other contextual computer vision models, in which operation on a crop is informed by contextual information from the pixels outside of the crop. A solution to the problem of insufficient information in a crop is to expand the bounds of the crop, however this can lead to the image classification model identifying a separate object in the crop rather than the object-of-interest if the increase in the bounds of the crop results in the introduction of new objects. Another problem in expanding the crop bounds is that unless crop resolution is decreased (which would result in loss of information), the increase in crop size will result in slower model training times and/or require additional computing resources. Furthermore, if a user was interested in the size estimates of an object using the size of the crop as a reference, they might overestimate the dimensions of the object due to the increase in crop size required to accurately detect the object, unless they transform the size estimate by the change in crop size.

In other alternate aspects, a user may alter other parameters when implementing the object detection service 120, such as the size of the larger image and the crop. Many object detection/image classification algorithms first compress an image to some common size (224×224 pixels, for example). A similar compression of the larger image would reduce model inference time. This aligns with benefits provided by the object detection service 120, whereby the larger image input provides general context regarding the object of interest, while the crop input provides the detailed information necessary for accurate classification. There are no strict requirements on the input sizes of the larger image and crop, provided their relative size and/or position to each other still adhere to the underlying principle of the object detection service 120. Furthermore, the optional positional information can also vary in form, provided it offers the supervised head of the object detection service 120 information of where the crop exists within or in-relation to the larger image. In one non-limiting aspect, the row and column indices of the crop within a grid-based cropping of the larger image were used as the position vector.

Finally, the object detection service 120 is not limited to using only two models and can theoretically use n models as long as information from the n models can be passed between models. This could be in a linear pipeline where model 1 feeds info into model 2 and then model 2 feeds into model 3 or a scenario in which models 1, 2, and 3 all feed directly into the supervised head. As another example, model results from n surrounding same-size crops may be used as context.

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method of detecting one or more objects in an image, the method comprising:
receiving a first portion of the image at a first feature extractor to provide a first feature vector, the first portion having an object depicted therein;
receiving a second portion of the image at a second feature extractor to provide a second feature vector, the second portion being different from the first portion; and
classifying the object using a classification model, wherein classifying the object comprises applying at least the first feature vector and the second feature vector to the classification model.

2. The method of claim 1, wherein the second portion is larger than the first portion and fully overlaps the first portion.

3. The method of claim 1, wherein the object is depicted in the second portion.

4. The method of claim 1, further comprising:
receiving positional information indicating a position of the first portion relative to at least the second portion,
wherein classifying the object further comprises applying the positional information to the classification model.

5. The method of claim 4,
wherein the second portion is the image, and
wherein the positional information comprises one of coordinates of the first portion within the image, and a position vector of the first portion within the image.

6. The method of claim 1, wherein one or both of the first feature extractor and the second feature extractor have pretrained fixed parameters, the method further comprising:
training the classification model using outputs from the first feature extractor and the second feature extractor.

7. The method of claim 1,
wherein the image depicts external surfaces of a plurality of sections of an aircraft,
wherein the first portion of image depicts an external surface of a first section of the plurality of sections,
wherein classifying the object comprises distinguishing the first section.

8. A computer program product comprising:
a computer-readable storage medium having computer-readable program code embodied therewith, the computer-readable program code executable by one or more computer processors to perform an operation comprising:
receiving a first portion of the image at a first feature extractor to provide a first feature vector, the first portion having an object depicted therein;
receiving a second portion of the image at a second feature extractor to provide a second feature vector, the second portion being different from the first portion; and
classifying the object using a classification model, wherein classifying the object comprises applying at least the first feature vector and the second feature vector to the classification model.

9. The computer program product of claim 8, wherein the second portion is larger than the first portion and fully overlaps the first portion.

10. The computer program product of claim 8, wherein the object is depicted in the second portion.

11. The computer program product of claim 8, the operation further comprising:
receiving positional information indicating a position of the first portion relative to at least the second portion,
wherein classifying the object further comprises applying the positional information to the classification model.

12. The computer program product of claim 11,
wherein the second portion is the image, and
wherein the positional information comprises one of coordinates of the first portion within the image, and a position vector of the first portion within the image.

13. The computer program product of claim 8, wherein one or both of the first feature extractor and the second feature extractor have pretrained fixed parameters, the operation further comprising:
training the classification model using outputs from the first feature extractor and the second feature extractor.

14. The computer program product of claim 8,
wherein the image depicts external surfaces of a plurality of sections of an aircraft,
wherein the first portion of image depicts an external surface of a first section of the plurality of sections,
wherein classifying the object comprises distinguishing the first section.

15. A system comprising:
one or more processors; and
a memory storing instructions that when executed by the one or more processors enable performance of an operation of detecting one or more objects in an image, the operation comprising:
receiving a first portion of the image at a first feature extractor to provide a first feature vector, the first portion having an object depicted therein;
receiving a second portion of the image at a second feature extractor to provide a second feature vector, the second portion being different from the first portion; and
classifying the object using a classification model, wherein classifying the object comprises applying at least the first feature vector and the second feature vector to the classification model.

16. The system of claim 15, wherein the second portion is larger than the first portion and fully overlaps the first portion.

17. The system of claim 15, wherein the object is depicted in the second portion.

18. The system of claim 15, the operation further comprising:
receiving positional information indicating a position of the first portion relative to at least the second portion,
wherein classifying the object further comprises applying the positional information to the classification model.

19. The system of claim 18,
wherein the second portion is the image, and
wherein the positional information comprises one of coordinates of the first portion within the image, and a position vector of the first portion within the image.

20. The system of claim 15, wherein one or both of the first feature extractor and the second feature extractor have pretrained fixed parameters, the operation further comprising:
training the classification model using outputs from the first feature extractor and the second feature extractor.
